(19) United States
(12) Patent Application Publication
(10) Pub. No.: US 2026/0250569 A1
(43) Pub. Date: Aug. 27, 2026

(54) BIOBASED DIELECTRIC COOLANTS USING INTERMEDIATES FROM OZONE CRACKING OF LIPIDS

(71) Applicant: Purdue Research Foundation, West Lafayette, IN (US)

(72) Inventors: Junli Liu, West Lafayette, IN (US); Nathan Scott Mosier, West Lafayette, IN (US)

(21) Appl. No.: 19/549,088

(22) Filed: Feb. 25, 2026

Related U.S. Application Data
(60) Provisional application No. 63/763,931, filed on Feb. 27, 2025.

(51) Int. Cl. C09K 5/10

(52) U.S. Cl. CPC C09K 5/10

(57) ABSTRACT

Biobased dielectric coolants and methods for making diverse high-quality biobased dielectric coolants using carboxylic acid and/or dicarboxylic acids produced from ozone cracking of lipids. The method can include reacting a fatty acid with one or more alcohols, diols, and/or triols to esterify the fatty acid to form esters having a kinematic viscosity @ 40° C. of less than 15 mm²/s, according to ASTM D 445. The carboxylic acids and dicarboxylic acids can be nonanoic acid, malonic acid, propanoic acid, hexanoic acid, and/or azelaic acid, and can be derived from the oxidation of one or more lipids by ozone cracking.

### BACKGROUND

### Field of the Invention

Embodiments of the present disclosure generally relate to dielectric coolants. More particularly, embodiments relate to dielectric coolants synthesized from oxidation products of biologically derived oils/fats.

### Description of the Related Art

Use of fossil energy has caused increased greenhouse gas (GHG) levels in the atmosphere and other related environmental problems. Net-zero emissions have been developed as targets globally by governments and companies to mitigate climate change to limit the temperature-increasing limit to 1.5° C. Carbon dioxide emissions were about 5 billion tons in the United States in 2021, and the transportation and industrial sectors account for over 50% of the total emissions. Internal combustion engine passenger vehicles will be phased out of production by 2035, and electric vehicles (EVs) will dominate passenger vehicles to reduce GHG emissions.

Batteries are the heart of EVs and can generate significant amounts of heat during operation and charging. Dielectric coolants have been developed and used to help make batteries work in an appropriate temperature range.

The transfer from internal combustion engines to EVs also creates a concern for the demand on the electrical grid. Energy usage shifting from combustion energy to electricity will dramatically increase demand on the electrical grid. Recent advances in AI technology also depends on electrical energy. All these require the electrical components to be operated under appropriate temperatures for the safety of humans and data storage.

Dielectric coolants can be used for batteries or electrical parts, such as those needed for AI computing, to conduct heat without conducting electricity. The global dielectric coolants market is forecasted to dramatically increase from $5.5 billion in 2022 to $11.9 billion in 2032. The demand for dielectric coolants in the United States alone is forecasted to increase to $3 billion by 2032. Current dielectric coolants are either hydrocarbons or fluorocarbons that are various types of mineral oil, silicone, fluorinated fluid, synthetic esters, etc. The main dielectric coolants are fossil-based and generate high greenhouse gases during production and disposal. The greenhouse gas potential of fluorocarbons can be 5000 to 10000 times that of carbon dioxide. Therefore, renewable bio-dielectric coolants, which are an alternative to fossil-based dielectric coolants using energy-efficient methods, are crucial for decarbonizing the dielectric coolant industry.

It has been recently discovered that natural oils and fats can be used to synthesize dielectric coolants with high flash points, renewability, and eco-friendliness. However, such synthesized dielectric coolants exhibit disadvantages, such as poor low-temperature performance, poor oxidation stability, low thermal stability, etc. These disadvantages result from the contradictory effect of saturated and unsaturated compounds in oil and fat. Long-chain fatty acids in the oil and fat result in the high crystallization point of the products, which constrain the low-temperature utilization limits. On the other hand, the unsaturated compounds cause oxidation or decomposition during the operation to deteriorate the products.

There is still a need, therefore, for methods to improve the low-temperature performance, thermal stability and oxidation stability of non-fossil-based oils and fats to replace fossil-based lubricants.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are, therefore, not to be considered limiting of its scope, for the invention may admit to other equally effective embodiments. It is emphasized that the figures are not necessarily to scale and certain features and certain views of the figures can be shown exaggerated in scale or in schematic for clarity and/or conciseness.

FIGS. 1A-1D show the FTIR spectra of nonanoic acid, various n-alcohols, and the resulting esters. In particular, FIG. 1A is the FTIR spectra of nonanoic acid, methanol, and synthesized methyl nonanoate (MNE). FIG. 1B is the FTIR spectra of nonanoic acid, ethanol, and synthesized ethyl nonanoate (ENE). FIG. 1C is the FTIR spectra of nonanoic acid, n-propanol, and synthesized propyl nonanoate (PNE). FIG. 1D is the FTIR spectra of nonanoic acid, butanol, and synthesized butyl nonanoate (BNE).

FIGS. 2A-2C show the FTIR spectra of nonanoic acid, various iso-alcohols and the resulting esters. In particular, FIG. 2A is nonanoic acid, iso-propanol, and synthesized isopropyl nonanoate (iPNE). FIG. 2B is the FTIR spectra of nonanoic acid, iso-butanol, and synthesized isobutyl nonanoate (iBNE). FIG. 2C is the FTIR spectra of nonanoic acid, iso-pentanol, and synthesized isopentyl nonanoate (iPENE).

FIGS. 3A-3D show the FTIR spectra of nonanoic acid, various polyols and the resulting diesters/triesters. FIG. 3A is the FTIR spectra of ethylene glycol (EG), nonanoic acid (NA), and resulting nonanoate (EGNE). FIG. 3B is the FTIR spectra of 1,2 propanediol (12PDO), nonanoic acid, and resulting nonanoate (12PDNE). FIG. 3C is the FTIR spectra of 1,3 propanediol (13PDO), nonanoic acid, and resulting nonanoate (13PDNE). FIG. 3D is the FTIR spectra of glycerol, nonanoic acid, and glycerol trinonanoate (TGNE).

FIGS. 4A-4F show the FTIR spectra of azelaic acid, various alcohols and the resulting synthesized diesters. In particular, FIG. 4A is the FTIR spectra of azelaic acid, methanol, and synthesized dimethyl azelate (DMAE). FIG. 4B is the FTIR spectra of azelaic acid, ethanol, and synthesized diethyl azelate (DEAE). FIG. 4C is the FTIR spectra of azelaic acid, propanol, and synthesized dipropyl azelate (DPAE). FIG. 4D is the FTIR spectra of azelaic acid, isopropanol, and synthesized diisopropyl azelate (DIPAE). FIG. 4E is the FTIR spectra of azelaic acid, butanol, and synthesized dibutyl azelate (DBAE). FIG. 4F is the FTIR spectra of azelaic acid, isobutanol, and synthesized diisobutyl azelate (DIBAE).

FIG. 5 shows the kinematic viscosity at 40° C. of the synthesized bio-dielectric coolants prepared according to one or more embodiments provided herein.

FIG. 6 shows the dielectric constant/relative permittivity at room temperatures (23-25° C.) under 1000 Hz of the synthesized bio-dielectric coolants prepared according to one or more embodiments provided herein.

FIG. 7 shows the breakdown voltage of the synthesized bio-dielectric coolants prepared according to one or more embodiments provided herein.

FIG. 8 shows the breakdown strength of the synthesized bio-dielectric coolants prepared according to one or more embodiments provided herein.

FIG. 9 shows the low-temperature performance of the synthesized bio-dielectric coolants prepared according to one or more embodiments provided herein.

FIG. 10 shows the TGA onset temperature and boiling points of the synthesized bio-dielectric coolants prepared according to one or more embodiments provided herein.

### SUMMARY OF THE INVENTION

Methods for making biobased dielectric coolants that are both non-toxic and renewable are provided herein. In at least one embodiment, the method includes reacting a fatty acid with at least one alcohol at conditions sufficient to esterify the fatty acid to form a fatty acid ester having a kinematic viscosity @ 40° C. of less than 15mm²/s, according to ASTM D 445, wherein the fatty acid is an ozonized product of one or more plant or animal based oil and/or fat.

In at least one other embodiment, the method includes oxidizing a fat or oil with ozone to provide one or more fatty acids; and reacting the one or more fatty acids with at least one alcohol at conditions sufficient to esterify the one or more fatty acids to form a fatty acid ester having a kinematic viscosity @ 40° C. of less than 15 mm²/s, according to ASTM D 445.

In at least one other embodiment, a method includes oxidizing a fat or oil with ozone to provide one or more fatty acids; and reacting glycerin with the one or more fatty acids to form one or more triglycerides having a kinematic viscosity @ 40° C. of less than 15 mm²/s, according to ASTM D 445.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various embodiments and across the figures provided herein. This repetition is for the purpose of simplicity and clarity and does not in itself dictate a relationship between the various embodiments and/or configurations. Moreover, the exemplary embodiments presented below can be combined in any combination of ways, i.e., any element from one exemplary embodiment can be used in any other exemplary embodiment, without departing from the scope of the disclosure.

In the following discussion and in the claims, the singular forms “a”, “an”, and “the” are intended to include the plural forms as well, unless the context clearly indicates otherwise. For example, embodiments using “an ester” include embodiments where one, two, or more esters are used, unless specified to the contrary or the context clearly indicates that only one olefin is used.

Further, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case, does not include any other component to a level greater than 3 wt %.

The term “or” is intended to encompass both exclusive and inclusive cases, i.e., “A or B” is intended to be synonymous with “at least one of A and B,” unless otherwise expressly specified herein. Moreover, certain embodiments and features will be described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated.

The term “wt %” means percentage by weight, “vol %” means percentage by volume, “mol %” means percentage by mole, “ppm” means parts per million, and “ppm wt” and “ppmw” are used interchangeably and mean parts per million on a weight basis. All concentrations herein, unless otherwise stated, are expressed on the basis of the total amount of the composition in question.

Unless otherwise indicated, all numerical values are “about” or “approximately” the indicated value, meaning the values take into account experimental error, machine tolerances and other variations that would be expected by a person having ordinary skill in the art. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for making the measurement.

Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

According to one or more embodiments described herein, dielectric coolants that are synthesized from plant lipids or other non-fossil-based oils or fats, and methods for making same are provided. In at least one specific embodiment, the dielectric coolants are synthesized from the oxidation of one or more unsaturated compounds using ozone cracking to convert long-chain unsaturated compounds to mid or short-saturated carboxylic acid intermediates, which can be used to synthesize fully saturated mid or short-chain esters. These mid or short-saturated carboxylic acid intermediates can react with one or more alcohols, diols, or glycerol to synthesize biobased esters, diesters, or triesters to provide biobased dielectric coolants that are both non-toxic and renewable.

In one or more embodiments, the long chain fatty acids can have carbon chain lengths of 16-25 carbon atoms after ozone cracking, preferably 16-19, and more preferably 18. Suitable mid-saturated carboxylic acid intermediates can have carbon chain lengths of from a low of about 3, 5 or 7 to a high of 9, 10, or 12. Suitable short-saturated carboxylic acid intermediates can have 3 or less carbon atoms.

In at least one specific embodiment, the dielectric coolants can be prepared by at least partially oxidizing plant lipids or other non-fossil-based oils or fats to provide one or more types of fatty acids. Preferable fatty acids include medium-chain fatty acids having an aliphatic tail that contains between 4 and 12 carbon atoms. The aliphatic tail also can have 2, 3, or 4 to 8, 10, or 12 carbon atoms. In at least one specific embodiment, the dielectric coolants are synthesized from one or more high oleic oils. High oleic oils are oil varieties characterized by high oleic acid, low saturated FFA, and low polyunsaturated FFA. These one or more fatty acids can then be reacted with one or more alcohols to esterify the fatty acid(s) to form a fatty acid ester that is suitable for use as a biobased coolant.

The term “high oleic acid” means any oil or oily mixture that contains at least 75 wt % of oleic acid. Suitable high oleic acids for use herein can also contain at least 80 wt %, at least 85 wt %, at least 90 wt %, at least 93 wt %, at least 95 wt %, at least 97 wt %, or at least 99 wt %. of oleic acid. The concentration of oleic acid in the high oleic acid can also range from a low of about 75 wt %, 78 wt %, or 82 wt % to a high of about 88 wt %, 90 wt %, or 95 wt %. In some embodiments, the high oleic acid consists of oleic acid or consists essentially of oleic acid.

The terms “low saturated free fatty acid” and “low saturated FFA” are interchangeable and both mean less than 10 wt % of saturated free FFA, or less than 8 wt % or less than 5 wt %, or less than 3 wt %, or less than 2 wt % or less than 1 wt %. A low saturated free fatty acid (FFA) can also have a saturated FFA content that ranges from a low of 0.01 wt %, 0.05 wt %, or 1.0 wt % to a high of 3 wt %, 7 wt % or 10 wt %.

The terms “low polyunsaturated free fatty acid” and “low polyunsaturated FFA” are interchangeable and both mean less than 20 wt % of polyunsaturated FFA, or less than 18 wt % or less than 15 wt %, or less than 13 wt %, or less than 21 wt % or less than 10 wt %. A low polyunsaturated free fatty acid (FFA) can also have a polyunsaturated FFA content that ranges from a low of 1.0 wt %, 2.0 wt %, or 3.0 wt % to a high of 13 wt %, 17 wt % or 20 wt %.

It was surprising and unexpected that non-fossil-based dielectric coolants synthesized from high oil(s) have longer oxidation stability than current dielectric coolants, higher thermal stability than current dielectric coolants, and can be adjusted to meet low-temperature environment applications. It was also surprising and unexpected to discover that the viscosity indices of these dielectric coolants synthesized from high oleic oil(s) can range from 100 to 190. The viscosity indices also can range from 100 to 185; 150 to 185; and 150 to 190. The viscosity indices also can range from a low of about 100, 115, or 125 to a high of about 165, 185, or 190.

In one or more other embodiments, a method for making dielectric coolants from one or more high oleic oil is provided. The high oleic oils can be cleaved through ozonolysis (i.e. ozone cracking) to one or more dicarboxylic acids (e.g., azelaic acid and malonic acid) and/or one or more monocarboxylic acids (e.g., nonanoic acid, hexanoic acid, and propanoic acid) with a high yield. The cleavage is preferably done by ozone cracking to provide one or more types of fatty acids. The resulting acids can then be reacted with one or more diols, triols, or other polyols to form esters that are suitable for use as lubricants. Nonanoic acid is a primary carboxylic acid in the ozone cracking of oleic acid, a mono-unsaturated omega-9 fatty acid found in various animal and vegetable sources.

Suitable high oleic oils and/or oleic acid can be derived from any suitable animal fats and/or vegetable oils. Preferred sources of high oleic oil include soybeans, canola, sunflowers, avocado and the like, as well as combinations thereof. For example, high oleic oils, such as soybean oil, canola oil, sunflower oil, vegetable oil, avocado oil, and conventional cooking oils, include oil varieties characterized by a high content of oleic acid, low saturated free fatty acid (FFA), and low polyunsaturated FFA.

Suitable alcohols for the esterification reaction can be or can include one or more diols, triols and/or other polyols. Such alcohols can be linear or branched or a mix of both linear and branched. The one or more alcohols can have 1 to 28 carbon atoms, such as 1 to 16 carbon atoms; 1 to 12 carbon atoms; 1 to 6 carbon atoms; 2 to 6 carbon atoms; 2 to 12 carbon atoms; 2 to 10 carbon atoms; or 2 to 8 carbon atoms. The one or more alcohols can be or can include n-alcohols having 1 to 12 carbon atoms or 2-12 carbon atoms. The one or more alcohols also can be or can include n-alcohols having 1 to 6 carbon atoms or 2-6 carbon atoms. The one or more alcohols also can be or can include iso-alcohols having 1 to 12 carbon atoms. The one or more alcohols also can be or can include iso-alcohols having 1 to 6 carbon atoms. The one or more alcohols also can be derived from syngas, a mixture of hydrogen and carbon monoxide. The one or more alcohols also can be derived from sugar or lignocellulose fermentation. The one or more alcohols also can be derived from biomass pyrolysis.

In at least one specific embodiment, the one or more alcohols can be or can include 1,3 propanediol and/or 1,2 propanediol. These 1,3 propanediol or 1,2 propanediol can be fermented or chemically synthesized from glycerol. In at least one specific embodiment, the one or more alcohols can be or can include glycerol.

In one or more specific embodiments, one or more triglycerides can be oxidized using ozone to provide a fatty acid comprising nonanoic acid, malonic acid, azelaic acid, or a mixture of both. These acids can then be reacted with at least one polyol to esterify the fatty acid to form a fatty acid ester. In one or more specific embodiments, glycerin can be used to react with malonic acid, nonanoic acid, and/or derivatives thereof to form one or more triglycerides or oligoesters suitable for use as biobased coolants. Glycerin is a readily available by-product of current biodiesel production and soap production, as well as a by-product of the hydrolysis of animal fats, plant fat and vegetable oils. One or more suitable polyols, including 1,2 propanediol and 1,3 propanediol, can be converted from glycerin by a biological fermentation process or chemical process.

In one or more embodiments above or elsewhere herein, one or more catalysts can be used in the reaction of the one or more fatty acids and the one or more alcohols to improve the reaction rate and yield. Any suitable acid catalyst can be used. For example, catalysts can include any one or more Bronsted acids. The catalyst can be homogenous or heterogeneous. The catalyst can be supported or unsupported. Suitable catalysts include methanesulfonic acid (MSA) and sulfuric acid. Ion exchange resins (strong acid type) can also be used. Other suitable catalysts including heterogeneous catalysts, such as MgF₂ and ZnF₂, are also able to do this conversion.

Preferred esterification reaction pressures are at or near atmospheric pressure. Preferred esterification reaction temperatures are about the approximate boiling points of the alcohol(s) to reach the fastest reaction rates. For example, suitable reaction temperatures include 60-70° C. for methanol; 72-82° C. for ethanol; 92-102° C. for 1-propanol; 78-88° C. for 2-propanol; 113-123° C. for 1-butanol; 105-115° C. for iso-butanol; and 126-136° C. for iso-pentanol. Additional reaction temperatures include 65° C. for methanol; 78° C. for ethanol; 97° C. for 1-propanol; 83° C. for 2-propanol; 118° C. for 1-butanol; 108° C. for iso-butanol; and 131° C. for iso-pentanol. In other embodiments, suitable reaction temperatures can range from a low of about 60, 70, or 80° C. to a high of about 110, 125, or 140° C.

The resulting esters, diesters, and triesters possess excellent viscosity, and high flash point, as well as significantly improved low-temperature performance and oxidation stability. These significantly improved qualities allow the FAEs to serve as dielectric coolants. In addition, the methods for making these esters have the potential to be more economical than conventional routes due to lower capital cost, low energy consumption, high FAE yield, and high value of the by-products. In addition, the methods provided herein also can increase sustainability by carbon sequestration because of the renewability of feedstocks.

Additional aspects of the present disclosure include any one or more of the following embodiments. [after claims are finalized.]

### EXAMPLES

Embodiments discussed and described herein can be further described with the following examples. Although the following examples are directed to specific embodiments, they are not to be viewed as limiting in any specific respect.

Esters from nonanoic acid with various mono and polyols were prepared and then analyzed and characterized by FTIR, cloud point, flash point, density, viscosity, differential scanning calorimetry (DSC), etc. Dielectric coolants were synthesized from the synthesized esters. The dielectric coolants showed excellent viscosity index and viscosity classification. The dielectric coolants also exhibited excellent thermal and oxidation stability as well as excellent low-temperature performance.

### Example 1: Ester Synthesis from Nonanoic Acid and N-Alcohol

Nonanoic acid (≥96%, Sigma Aldrich Inc.) was reacted with various mono alcohols to form esters in the presence of methanesulfonic acid (MSA, 99%, Sigma Aldrich Inc.) as the homogenous catalyst. The esterification reactions were performed in a 2L, 3-neck round bottom flask under reflux at atmospheric pressure. The flask was heated by a digital heating mantle with mixing (USA Lab). The reflux condenser connected to the flask was cooled with a water-propylene glycol mixture chilled to 1° C. using a chill circulator (RTE-111, NESLab).

The alcohols were methanol (≥99.9%, Sigma Aldrich Inc.), 200 proof ethanol (100%, Decon Laboratories Inc.), 1-propanol (≥99.9%, Sigma Aldrich Inc.), 2-propanol ((≥99.9%, Sigma Aldrich Inc), 1-butanol (99.9%, Sigma Aldrich Inc.), iso-butanol (≥99.9%, Supelco Inc.), and isopentanol (≥99.9%, Sigma Aldrich Inc.).

In this example, 1.5 moles of nonanoic acid and 9 moles of specific alcohol were poured into the reactor, and the solution was heated to the targeted temperatures, depending on the type of alcohol. The targeted temperatures were 60-70° C. for methanol, 72-82° C. for ethanol, 92-102° C. for 1-propanol, 78-88° C. for 2-propanol, 113-123° C. for 1-butanol, 105-115° C. for iso-butanol; and 126-136° C. for iso-pentanol. Once the solution reached the targeted temperature, 0.075 moles of MSA (7.42 g of 99% MSA) were added. After the reaction solution was kept at the targeted temperature for 3 hours, the extra alcohol and synthesized water were evaporated using a rotary evaporator (BUCHI R200). Then, the residual mixtures were transferred into the 2 L flask. 4.5 moles of alcohol were added into the flask with 0.025 moles of MSA (2.37 g of 99% MSA). The solution was heated to the targeted temperature as previously described and kept at the targeted temperature for 2 hours. After removing the extra alcohol and water generated as a byproduct of the reaction using a rotary evaporator (BUCHI R-200), the residual mixture was poured into a 2 L separation funnel, and 200 ml of hexane and 400 ml of deionized water were added and vigorously mixed. The mixture was allowed to settle for 30 minutes to separate the organic and aqueous layers. The previous hexane/water extraction step was repeated over 5 times until the aqueous layer became clear, and the pH difference between the aqueous layer and de-ion water was <0.5. After draining the bottom aqueous layer, the top organic mixture was poured into a 1 L flask, and hexane/water was removed to obtain the purified esters.

### Example 2: Diester Synthesis from Nonanoic Acid and Diol

Esterification of nonanoic acid with different diols was performed in a 1 L round bottom flask. Nonanoic acid (≥96%, Sigma Aldrich Inc.) was reacted with the diols to form esters in the presence of methanesulfonic acid (MSA, 99%, Sigma Aldrich Inc.) as the homogenous catalyst. Diols used in the synthesis were ethylene glycol, 1,2 propanediol, and 1,3 propanediol. In this example, 0.5 moles of diols (ethylene glycol, 1,2 propanediol, and 1,3 propanediol) and 1 mole of nonanoic acid were put into a 1-L flask. Then, 0.02 mol of methanesulfonic acid (MSA) solution was added to the mixture. The flask was connected to a rotor evaporator with the vacuum at −10 inch Hg for 1 hour. Then, the vacuum was increased to −25 inch Hg for another 5 hours to remove water to move the reaction to the products. Then, the residual mixture was poured into a 1 L separation funnel, and 100 ml of hexane and 200 ml of deionized water were added and vigorously mixed. The mixture was allowed to settle for 30 minutes to allow organic and aqueous layers separation. The previous hexane/water extraction step was repeated over 5 times until the aqueous layer became clear, and the pH difference between the aqueous layer and de-ion water was less than 0.5. The top organic mixture was poured into a 1 L flask, and hexane/water was removed to obtain the purified esters.

### Example 3: Diester Synthesis from Azelaic Acid and Monohydric Alcohols

Esterification of azelaic acid with different monohydric alcohols was performed in a 2 L 3-neck round bottom flask. The flask was heated by a digital heating mantle with mixing (USA Lab). A condenser was connected to the flask to inhibit the alcohol evaporation, and the condensation temperature was controlled by a chill circulator (RTE-111, NESlab) at 1° C. The alcohols used in this study included methanol (≥99.9%, Sigma Aldrich Inc.), 200 proof ethanol (100%, Decon Laboratories Inc.), 1-propanol (≥99.9%, Sigma Aldrich Inc.), 2-propanol (≥99.9%, Sigma Aldrich Inc), 1-butanol (99.9%, Sigma Aldrich Inc.), and iso-butanol (≥99.9%, Supelco Inc.).

Azelaic acid (98%, Thermo Scientific Chemicals Inc.) was reacted with alcohol to form diesters in the presence of methanesulfonic acid (MSA, 99%, Sigma Aldrich Inc.) as the homogenous catalyst. In this example, 2 moles of azelaic acid and 12 moles of specific alcohol were poured into the reactor, and the solution was heated to the targeted temperatures, depending on the type of alcohol. The targeted temperatures were 60-70° C. for methanol, 72-82° C. for ethanol, 92-102° C. for 1-propanol, 78-88° C. for 2-propanol, 113-123° C. for 1-butanol, 105-115° C. for iso-butanol; and 126-136° C. for iso-pentanol. Once the solution reached the targeted temperature, 0.05 moles of MSA (4.95 g of 99% MSA) were added. After the reaction solution was kept at the targeted temperature for 3 hours, the extra alcohol and synthesized water were evaporated using a rotary evaporator (BUCHI R200). Then, the residual mixtures were transferred into the 2 L flask. 6 moles of alcohol were added into the flask with 0.025 moles of MSA (2.37 g of 99% MSA). The solution was heated to the targeted temperature as previously described and kept at the targeted temperature for 2 hours. After removing the extra alcohol and synthesized water using a rotary evaporator (BUCHI R-200), the residual mixture was poured into a 2 L separation funnel, and 200 ml of hexane and 400 ml of deionized water were added and vigorously mixed. The mixture was allowed to settle for 30 minutes to separate the organic and aqueous layers. The previous hexane/water extraction step was repeated over 5 times until the aqueous layer became clear, and the pH difference between the aqueous layer and de-ion water was less than 0.5. After draining the bottom aqueous layer, the top organic mixture was poured into a 1 L flask, and hexane/water was removed to obtain the purified esters.

### Example 4: Triester Synthesis from Nonanoic Acid and Polyhydric Alcohol (Glycerol)

0.5 moles of glycerol and 1.5 moles of nonanoic acid were put into a 1-L flask. Then, 1.94 g of methanesulfonic acid (MSA) solution was added to the mixture. The flask was connected to a rotor evaporator with the vacuum at −10 inch Hg for 1 hour. Then, the vacuum was increased to −25 inch Hg for another 5 hours to remove water to move the reaction to the products. Then, the residual mixture was poured into a 1 L separation funnel, and 100 ml of hexane and 200 ml of deionized water were added and vigorously mixed. The mixture was allowed to settle for 30 minutes for organic and aqueous layers separation. The previous hexane/water extraction step was repeated over 5 times until the aqueous layer became clear, and the pH difference between the aqueous layer and de-ion water was less than 0.5. The top organic mixture was poured into a 1 L flask, and hexane/water was removed to obtain the purified esters.

The purified esters prepared according to Examples 1-4 were analyzed and characterized by FTIR, cloud point, flash point, density, viscosity, differential scanning calorimetry (DSC), etc.

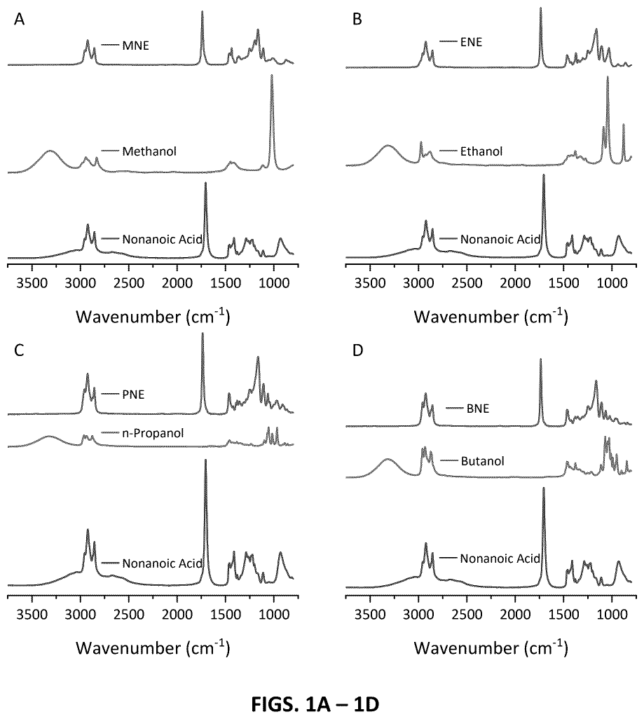

FIGS. 1A-1D show the FTIR spectra of nonanoic acid, various n-alcohols, and the synthesized esters of Example 1. In particular, FIG. 1A is the FTIR spectra of nonanoic acid, methanol, and synthesized methyl nonanoate (MNE). FIG. 1B is the FTIR spectra of nonanoic acid, ethanol, and synthesized ethyl nonanoate (ENE). FIG. 1C is the FTIR spectra of nonanoic acid, n-propanol, and synthesized propyl nonanoate (PNE). FIG. 1D is the FTIR spectra of nonanoic acid, butanol, and synthesized butyl nonanoate (BNE).

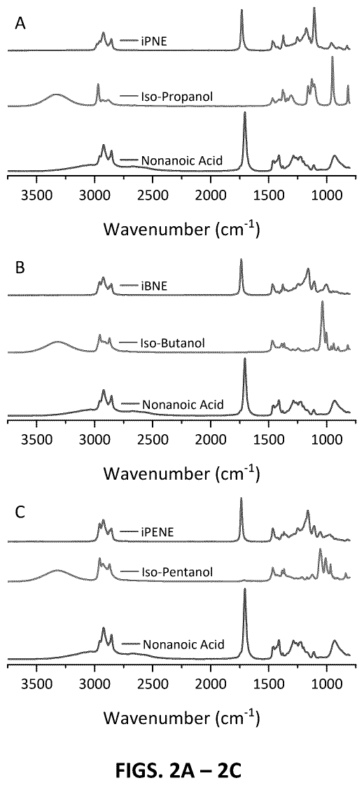

FIGS. 2A-2C show the FTIR spectra of nonanoic acid, various iso-alcohols and the synthesized esters of Example 1. In particular, FIG. 2A is the FTIR spectra of nonanoic acid, iso-propanol, and synthesized isopropyl nonanoate (iPNE). FIG. 2B is the FTIR spectra of nonanoic acid, iso-butanol, and synthesized isobutyl nonanoate (iBNE). FIG. 2C is the FTIR spectra of nonanoic acid, iso-pentanol, and synthesized isopentyl nonanoate (iPENE).

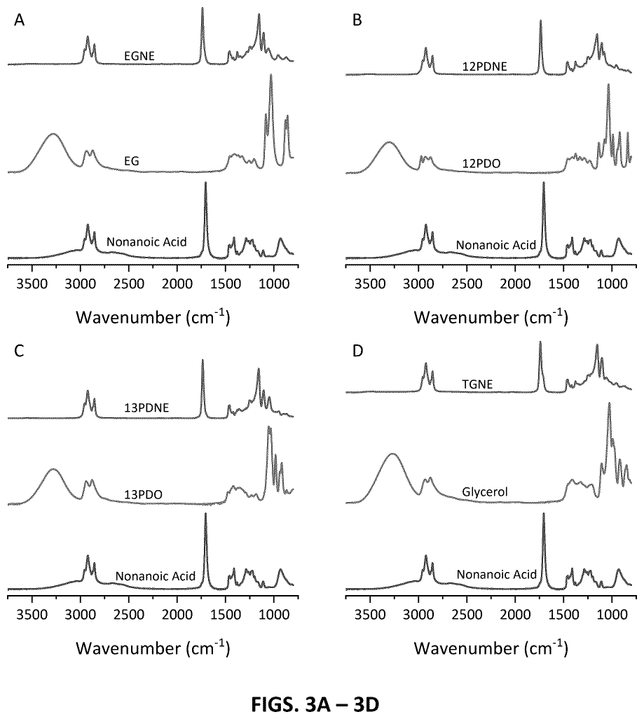

FIGS. 3A-3D show the FTIR spectra of nonanoic acid, various polyhdyric alcohols and the synthesized diesters/triesters of Example 2 and. FIG. 3A is the FTIR spectra of ethylene glycol (EG), nonanoic acid (NA), and resulting nonanoate (EGNE). FIG. 3B is the FTIR spectra of 1,2 propanediol (12PDO), nonanoic acid, and resulting nonanoate (12PDNE). FIG. 3C is the FTIR spectra of 1,3 propanediol (13PDO), nonanoic acid, and resulting nonanoate (13PDNE). FIG. 3D is the FTIR spectra of glycerol, nonanoic acid, and glycerol trinonanoate (TGNE).

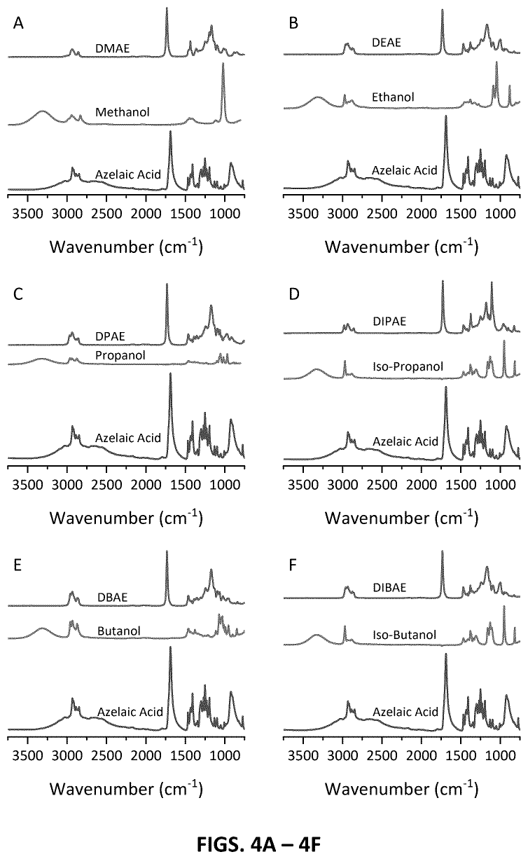

FIGS. 4A-4F show the FTIR spectra of azelaic acid, various alcohols and the various synthesized diesters of Example 3. In particular, FIG. 4A is the FTIR spectra of azelaic acid, methanol, and synthesized dimethyl azelate (DMAE). FIG. 4B is the FTIR spectra of azelaic acid, ethanol, and synthesized diethyl azelate (DEAE). FIG. 4C is the FTIR spectra of azelaic acid, propanol, and synthesized dipropyl azelate (DPAE). FIG. 4D is the FTIR spectra of azelaic acid, isopropanol, and synthesized diisopropyl azelate (DIPAE). FIG. 4E is the FTIR spectra of azelaic acid, butanol, and synthesized dibutyl azelate (DBAE). FIG. 4F is the FTIR spectra of azelaic acid, isobutanol, and synthesized diisobutyl azelate (DIBAE).

### Example 5: Dielectric Coolants Synthesized from the Oil/Fat Ozonolysis Products

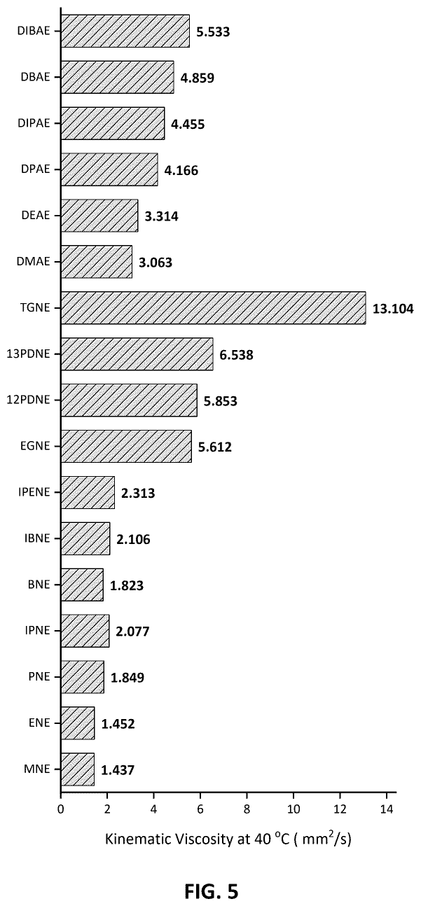

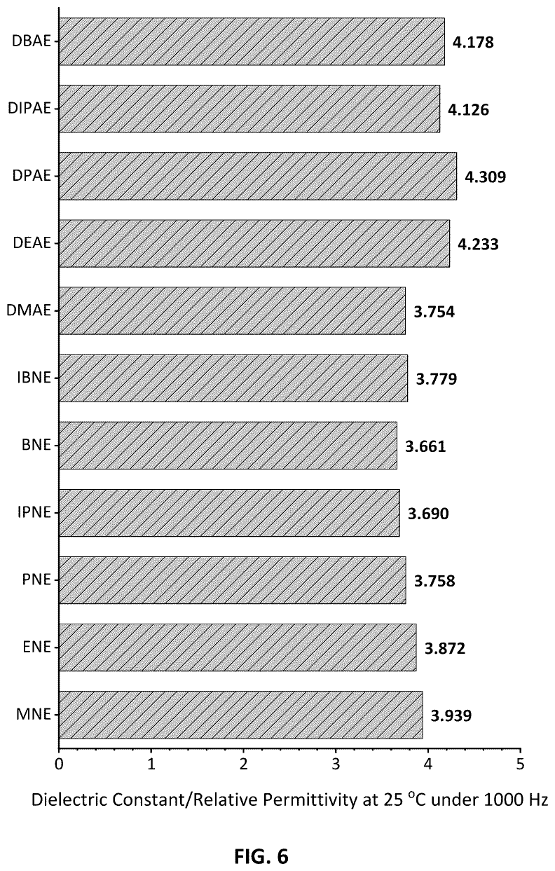

Dielectric coolants were synthesized from the oil/fat ozonolysis products from Examples 1-4. The dielectric coolants showed excellent viscosity index and viscosity classification as shown in FIG. 5. The dielectric coolants also exhibited excellent thermal and oxidation stability as well as excellent low-temperature performance as shown in FIGS. 6-10.

FIG. 5 depicts the kinematic viscosity of the synthesized bio-dielectric coolants at 40° C. The viscosity of the synthesized bio-dielectric coolants significantly depends on the compounds' structures. All synthesized bio-dielectric coolants have viscosity values of less than 15 mm²/s, indicating less resistance when running in pipelines and less pump energy consumption. Additionally, esters have been proven to be less influenced by temperatures. Therefore, these ester-based bioelectric coolants can provide better temperature resistance in terms of viscosity.

FIG. 6 shows the dielectric constant/relative permittivity at 25° C. under 1000 Hz. Relative permittivities, previously called dielectric constants, are the ratios of electric permittivities to vacuum permeability. They show the materials'capabilities to store electric energy in an electric field. The synthesized bio-dielectric coolants have relative permittivities of about four, and these values are compared to PTFE/Teflon (2.1), Polyimide (3.4) silicon dioxide (3.9), concrete (4.5), silicone rubber (2.9-4), etc.

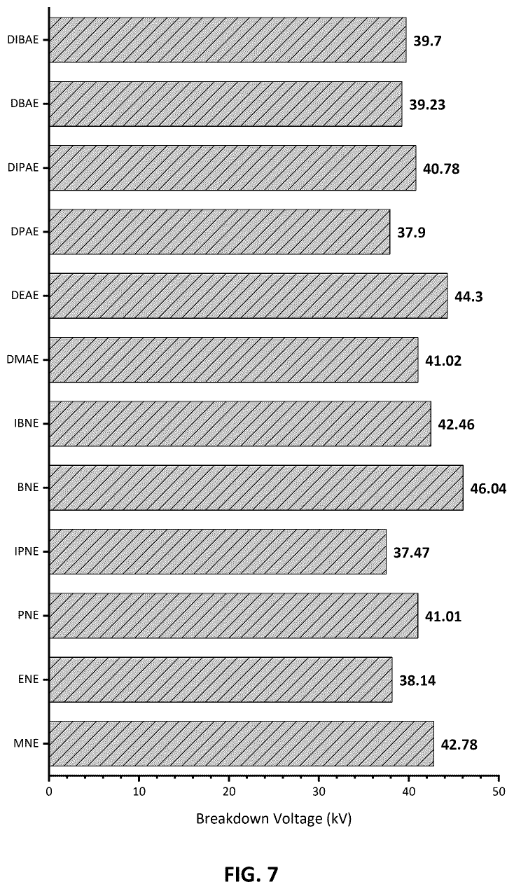

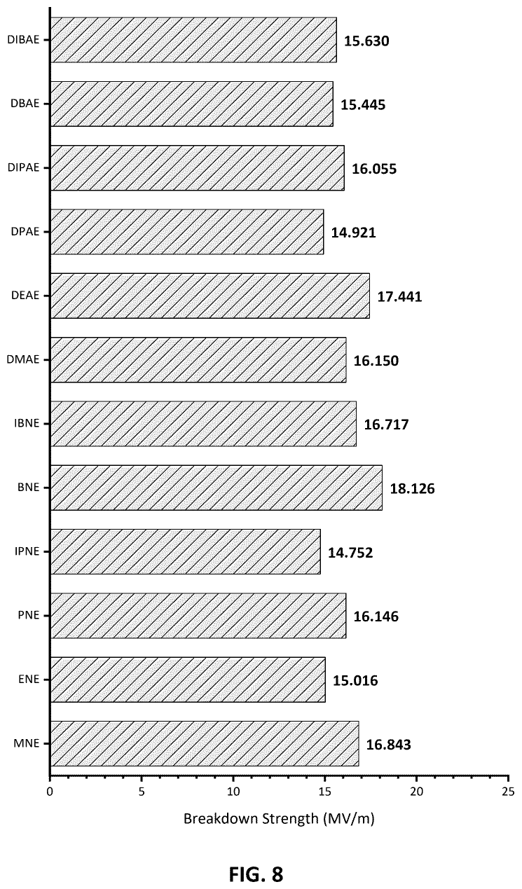

FIG. 7 shows the breakdown voltage of synthesized bio-dielectric coolants and FIG. 8 shows the breakdown strength of synthesized bio-dielectric coolants. The electric breakdown voltages of synthesized bio-dielectric coolants were determined according to ASTM D 877. The breakdown voltages ranged from 37 to 46 kV (FIG. 7), and the calculated breakdown strength ranged from 14 to 19 MV/m (FIG. 8). These values are compared to mineral oil/silicon oil (10-15 MV/m), Teflo (19.7 MV/m), Polystyrene (19.7 MV/m), and lead zirconate titanate (10-25 MV/m).

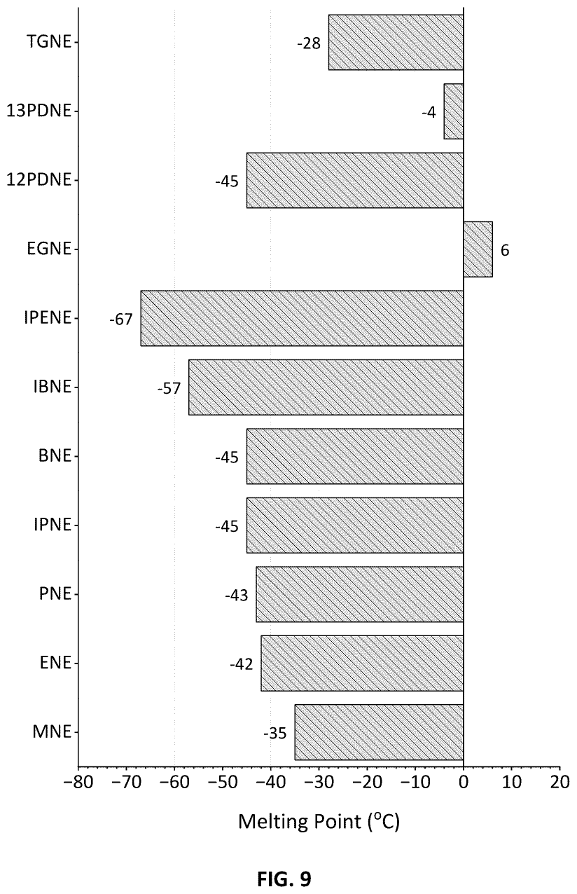

FIG. 9 depicts the low-temperature performance of the synthesized bio-dielectric coolants. Low-temperature performance was evaluated according to ASTM D 2500. As the synthesized bio-dielectric coolants are purified single compounds, the detected cloud points were the melting points. Melting points of the bio-dielectric coolants significantly depended on the structures of the compounds. Melting points of the bio-dielectric coolants determined the low temperature utilization limits.

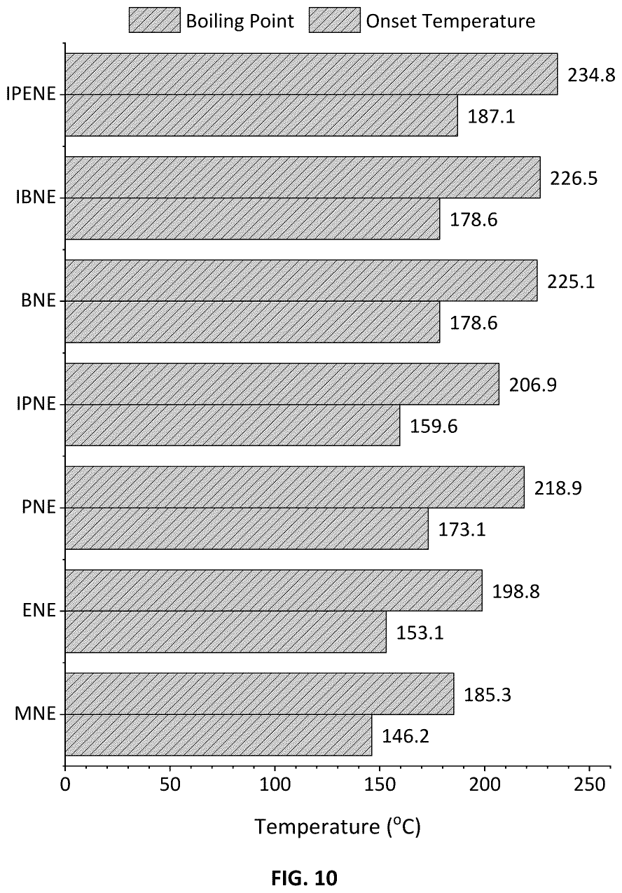

FIG. 10 depicts the TGA onset temperature and boiling points. Thermal stability was evaluated using the TGA analysis. However, the onset temperature of weight loss in TGA doesn't correspond to the decomposition temperature, as the bonds in the synthesized compounds are very stable. Boiling point tests showed these onset temperatures were close to the boiling point (FIG. 10). All these results show the compounds are stable below the boiling point, and the boiling points are the upper limited temperature for utilization.

The bio-dielectric coolants exhibited excellent oxidation stability owing largely to the saturated molecules, which have no carbon-carbon double bonds. The oxidation stability tests also showed no indication of oxidation even after 100 hours of oxidation stability tests. Test methods and procedures FTIR characterization

FTIR analysis was performed by a Nicolet Nexus FTIR (Thermo Fisher Scientific, USA), and the samples were analyzed in a spectral region between 4000 and 800 cm⁻¹ with a 2 cm⁻¹ resolution. The samples for FTIR analysis included nonanoic acid, diols (ethylene glycol, 1,2 propanediol, and 1,3 propanediol), glycerol, and products formed from the reactions described previously. Cloud point detection

Cloud point was measured according to the ASTM D 2500. In the cloud point detection, a stainless-steel cylinder was immersed in the ethanol bath, and the temperature was chilled by adding dry ice. A glass test tube with about 25 mL moisture-free sample was settled into the cylinder. The cloud point was recorded as the temperature of observing waxy clouds or haze. Flash point detection

Flash points were tested according to ASTM D 93 in a Pensky-Martens closed cup apparatus. About 70 mL samples were filled into the testing cup. The sample was heated at 2° C./min and used an appropriate thermal meter to measure the temperature (depending on the temperature range). The mixture was stirred at 90 RPM. When the temperature was about 23±5° C. below the expected flash point, the ignition sources were started applying. The flash point was recorded when the ignition source application caused a distinct flash in the interior of the testing cup.

### Density and Viscosity

The density and viscosity were measured according to ASTM D 4052 and ASTM D 445, respectively. These tests were performed by Iowa Central Fuel Testing Laboratory, a BQ-9000-certified lab. For the density tests by ASTM D 4502, about 2 mL of a liquid sample is introduced manually by a syringe into the tight temperature-controlled oscillating U-tube (at 15° C.), and the change in oscillating frequency caused by the change in the mass of the U-tube is used in conjunction with calibration data to determine the density. For the viscosity tests by ASTM D 445, the time for a volume of liquid to flow under gravity through a calibrated glass capillary viscometer inside a viscosity bath (40° C.) was measured.

### DSC Analysis

DSC analysis was performed by a Q 2000 DSC instrument (TA Instruments, England) with a refrigerated cooling accessory (TA Instruments, England). Nitrogen was purged into the system at 40 mL/min during analysis. The sample was cooled at the rate of 1° C./min to −40° C. after being at the isotherm at 20° C. for 3 mins. Then, it was heated to 20° C. at the rate of 1° C./min after being isotherm at −40° C. for 3 min. About 10 μL samples were used in each analysis.

### TGA Analysis

A TGA 4000 (Perkin Elmer, USA) was used to assess the thermal degradation by weight loss using nonisothermal and isothermal methods under a nitrogen atmosphere (20 mL/min). Nonisothermal heating was used to determine the Tonset of dielectric coolants (esters and oligomers) with 15-25 mg at 15° C./min from 40 to 550° C. Tonset was calculated by the tangent intersection of the baseline and degradation curve. The tangent intersection method was performed within the Origin software.

### Dielectric Breakdown Strength and Voltage

Dielectric breakdown strength and voltage were measured according to ASTM D 877, and the procedure can be briefly described as the following. The testing cup was filled with the samples, and the electrodes had an interval of 1 inch. The voltage applied to the sample started at zero and recorded the maximum voltage as the breakdown voltage when the liquid sample became breakdown. Structure of the biobased dielectric coolants

Once the esters were formed from carboxylic acids and/or dicarboxylic acids with the one or more alcohols, diols, or glycerol, the carboxylic acid group was changed to the ester group. This phenomenon can be proved in the FTIR analysis by two peak changes in FIG. 1 to FIG. 4: 1) the broach peak corresponding to OH in alcohols, diols and glycerol between 3000-3500 cm⁻¹ disappeared in the synthesized compounds; 2) carbonyl group (C═O) corresponding to nonanoic acid or azelaic acid was shift from 1705.6 cm⁻¹ to 1735.7 cm⁻¹ in the formed nonanoates or azelates.

Other specific embodiments provided herein further include any one or more of the following numbered Embodiments 1-18:

Embodiment 1: A method for making a biobased dielectric coolant, comprising: reacting a fatty acid with at least one alcohol at conditions sufficient to esterify the fatty acid to form a fatty acid ester having a kinematic viscosity @ 40° C. of less than 15 mm²/s, according to ASTM D 445, wherein the fatty acid is an ozonized product of one or more plant or animal based oil and/or fat.

Embodiment 2: The method according to Embodiment 1, wherein the fatty acid is nonanoic acid, azelaic acid, malonic acid, or a mixture thereof.

Embodiment 3: The method according to Embodiments 1 or 2, wherein the fatty acid is an ozonized product of a high oleic oil.

Embodiment 4: The method according to Embodiment 1, wherein the fatty acid is azelaic acid that is an ozonized product of one or more lipids.

Embodiment 5: The method according to any Embodiments 1 to 4, wherein the fatty acid is produced by oxidizing an oil containing oleic acid using ozone cracking.

Embodiment 6: The method according to any Embodiments 1 to 5, wherein the fatty acid comprises one or more medium-chain fatty acids having an aliphatic tail with between 4 and 12 carbon atoms

Embodiment 7: The method according to any Embodiments 1 to 6, wherein the at least one alcohol is a diol having 2 to 12 carbon atoms.

Embodiment 8: The method according to any Embodiments 1 to 6, wherein the at least one alcohol is selected from the group consisting of ethylene glycol, 1,2 propanediol, 1,3 propanediol, and glycerol.

Embodiment 9: A method for making a biobased dielectric coolant, comprising: oxidizing a fat or oil with ozone to provide one or more fatty acids; and reacting the one or more fatty acids with at least one alcohol at conditions sufficient to esterify the one or more fatty acids to form a fatty acid ester having a kinematic viscosity @ 40° C. of less than 15 mm²/s, according to ASTM D 445.

Embodiment 10: The method according to Embodiment 9, wherein the high oleic oil is derived from soybeans, canola, sunflowers, or a combination thereof.

Embodiment 11: The method according to Embodiments 9 or 10, wherein the fatty acid comprises one or more medium-chain fatty acids having an aliphatic tail with between 4 and 12 carbon atoms

Embodiment 12: The method according to any Embodiments 9 to 11, wherein the at least one alcohol is a diol having 2 to 12 carbon atoms.

Embodiment 13: The method according to any Embodiments 9 to 11, wherein the at least one alcohol is selected from the group consisting of ethylene glycol, 1,2 propanediol, 1,3 propanediol, and glycerol.

Embodiment 14: A method for making a biobased dielectric coolant, comprising: oxidizing a fat or oil with ozone to provide one or more fatty acids; and reacting glycerin with the one or more fatty acids to form one or more triglycerides having a kinematic viscosity @40° C. of less than 15 mm²/s, according to ASTM D 445.

Embodiment 15: The method according to Embodiment 14, wherein the glycerin is derived from animal fat, plant fat or petroleum.

Embodiment 16: The method according to Embodiments 14 or 15, wherein the fat or oil is derived from soybeans, canola, sunflowers, or a combination thereof.

Embodiment 17: The method according to any Embodiments 14 to 16, wherein the one or more fatty acids comprises azelaic acid.

Embodiment 18: The method according to any Embodiments 14 to 16, wherein the one or more fatty acids are selected from the group consisting of nonanoic acid, azelaic acid, malonic acid, hexanoic acid, and propanoic acid.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

As previously mentioned, certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, meaning the values take into account experimental error, machine tolerances and other variations that would be expected by a person having ordinary skill in the art.

The foregoing has also outlined features of several embodiments so that those skilled in the art can better understand the present disclosure. Those skilled in the art should appreciate that they can readily use the present disclosure as a basis for designing or modifying other methods or devices for carrying out the same purposes and/or achieving the same advantages of the embodiments disclosed herein. Those skilled in the art should also realize that such equivalent constructions do not depart from the spirit and scope of the present disclosure, and that they can make various changes, substitutions, and alterations herein without departing from the spirit and scope of the present disclosure, and the scope thereof is determined by the claims that follow.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A method for making a biobased dielectric coolant, comprising:
reacting a fatty acid with at least one alcohol at conditions sufficient to esterify the fatty acid to form a fatty acid ester having a kinematic viscosity @ 40° C. of less than 15 mm²/s, according to ASTM D 445, wherein the fatty acid is an ozonized product of one or more plant or animal based oil and/or fat.

2. The method of claim 1, wherein the fatty acid is nonanoic acid, azelaic acid, malonic acid, or a mixture thereof.

3. The method of claim 1, wherein the fatty acid is an ozonized product of a high oleic oil.

4. The method of claim 2, wherein the fatty acid is azelaic acid that is an ozonized product of one or more lipids.

5. The method of claim 1, wherein the fatty acid is produced by oxidizing an oil containing oleic acid using ozone cracking.

6. The method of claim 1, wherein the fatty acid comprises one or more medium-chain fatty acids having an aliphatic tail with between 4 and 12 carbon atoms.

7. The method of claim 1, wherein the at least one alcohol is a diol having 2 to 12 carbon atoms.

8. The method of claim 1, wherein the at least one alcohol is selected from the group consisting of ethylene glycol, 1,2 propanediol, 1,3 propanediol, and glycerol.

9. A method for making a biobased dielectric coolant, comprising:
oxidizing a fat or oil with ozone to provide one or more fatty acids; and
reacting the one or more fatty acids with at least one alcohol at conditions sufficient to esterify the one or more fatty acids to form a fatty acid ester having a kinematic viscosity @ 40° C. of less than 15 mm²/s, according to ASTM D 445.

10. The method of claim 9, wherein the high oleic oil is derived from soybeans, canola or sunflowers, or a combination thereof.

11. The method of claim 9, wherein the fatty acid comprises one or more medium-chain fatty acids having an aliphatic tail with between 4 and 12 carbon atoms.

12. The method of claim 9, wherein the at least one alcohol is a diol having 2 to 12 carbon atoms.

13. The method of claim 9, wherein the at least one alcohol is selected from the group consisting of ethylene glycol, 1,2 propanediol, 1,3 propanediol, and glycerol.

14. A method for making a biobased dielectric coolant, comprising:
oxidizing a fat or oil with ozone to provide one or more fatty acids; and
reacting glycerin with the one or more fatty acids to form one or more triglycerides having a kinematic viscosity @ 40° C. of less than 15 mm²/s, according to ASTM D 445.

15. The method of claim 14, wherein the glycerin is derived from animal fat, plant fat or petroleum.

16. The method of claim 14, wherein the fat or oil is derived from soybeans, canola, sunflowers, or a combination thereof.

17. The method of claim 14, wherein the one or more fatty acids comprises azelaic acid.

18. The method of claim 14, wherein the one or more fatty acids are selected from the group consisting of nonanoic acid, azelaic acid, malonic acid, hexanoic acid, and propanoic acid.
